(19) United States
(12) Patent Application Publication
(10) Pub. No.: US 2025/0124590 A1
(43) Pub. Date: Apr. 17, 2025

(54) SENSORY ESTIMATES AND/OR PREDICTIONS OF MORPHOMETRY

(71) Applicant: Oregon State University, Corvallis, OR (US)

(72) Inventors: Susan Elizabeth Hilber Piacenza, Corvallis, OR (US); Joseph R. Piacenza, III, Corvallis, OR (US); Kenneth John Faller, II, Corvallis, OR (US); Elliott Joseph Chimienti, Corvallis, OR (US)

(73) Assignee: Oregon State University, Corvallis, OR (US)

(21) Appl. No.: 18/905,107

(22) Filed: Oct. 2, 2024

Related U.S. Application Data
(60) Provisional application No. 63/589,968, filed on Oct. 12, 2023.

(51) Int. Cl. G06T 7/60; G06T 7/70

(52) U.S. Cl. CPC G06T 7/60; G06T 7/70; G06T 2207/10012; G06T 2207/10032; G06T 2207/20084; G06T 2207/30252

(57) ABSTRACT

Briefly, embodiments of an apparatus including at least one computing device that includes at least one processor and at least one non-transitory storage medium, for example, are described. The at least one non-transitory storage medium, in an embodiment, includes executable instructions stored thereon in which executing the instructions by the at least one processor are to result in processing sensor measurements, including images, from at least one optical sensor array, of at least one object. In an embodiment, for example, sensor measurements are processed with a three-dimensional pose estimation model to produce at least one substantially view-invariant morphometric measurement estimate of the at least one object.

### CLAIM OF PRIORITY

This application claims priority to U.S. Provisional Patent Application No. 63/589,968, filed Oct. 12, 2023, titled, “SENSORY ESTIMATES AND/OR PREDICTIONS OF MORPHOMETRY, INCLUDING TO INFORM POPULATION HEALTH,” which is incorporated by reference in its entirety for all purposes. Each of these applications is hereby incorporated by reference in its entirety for all purposes.

### TECHNICAL FIELD

This disclosure relates to making estimates and/or predictions of morphometric measurements from captured sensor measurements, including from captured images, such as to inform object population health, status and/or management decisions.

### BACKGROUND

There are many objects in the world that have a complex shape, including living creatures, such as animals, which may include livestock and/or aquatic life, for example. Living creatures, such as animals, may move around in their environment freely. It may not always be easy and/or safe to get close to these living creatures. It may, therefore, at times be a challenging problem to identify such living creatures and/or measure the size and/or shape (as well as other aspects) of those living creatures (e.g., their morphometry) if such living creatures are regularly and/or frequently moving around at a distance.

### BRIEF DESCRIPTION OF THE DRAWINGS

Claimed subject matter and examples are particularly pointed out and distinctly claimed in the concluding portion of the specification. However, both as to organization and/or method of operation, together with objects, features, and/or advantages thereof, it may best be understood by reference to the following detailed description if read with the accompanying drawings in which:

FIG. 1 is a schematic of an apparatus, in accordance with at least one example;

FIG. 2 is a schematic diagram of a computing and/or communications network that includes several computing devices able to mutually communicate via the computing and/or communications network with at least one of the computing devices capable of processing sensor measurements, in accordance with at least one example; and

FIG. 3 is a flow diagram in which sensor measurements, including images, are processed for image rectification, image triangulation, and machine learning processes, in accordance with at least one example.

### DETAILED DESCRIPTION

Here, terms such as living objects, living creatures, creatures, animals, and/or the like, are used interchangeably without loss of generality. Morphometry refers to the quantitative measurement and/or analysis of the shape, size, and/or dimensions of objects. While it may be applied to living creatures, including humans, in the study of the anatomy and/or physical characteristics of living organisms, it may also be used in various fields to analyze the properties of non-living objects, such as geological formations, engineering structures, and/or digital images. It is intended that the scope of claimed subject matter include the foregoing and not be limited to living objects, as this technology may be used and applied to non-living objects, and infer other object attributes, not limited to mass (e.g., rock formation stability, structural integrity of a bridge, etc.).

As discussed herein, it is challenging to identify living creatures and/or measure the size and/or shape (as well as other aspects) of those living creatures (e.g., their morphometry) if such living creatures are regularly and/or frequently moving around at a distance. Examples of such challenges include knowledge of precise position with respect to an object, not limited to altitude; having a living object measured orthogonal to a sensor, not limited to a camera, used for gathering measurements; and having a water dwelling living object be available for measurement out of its environment or at the surface of the water. Furthermore, measurement error may still be sufficiently large to make the measurements not sufficiently accurate to be of use at least for relatively smaller living objects. It is noted in this context that a camera is simply one example of a sensor capable of obtaining measurements; however, the measurements may be in the form of imagery and/or video.

Concomitantly, advances in photogrammetry, such as by adding a camera to unmanned aerial vehicles (UAV), such as a drone, have made remote measurements of living objects more accessible. However, challenges remain including sufficient accuracy for desired applications, excessive cost, having trained and/or skilled operators for such systems, and implementation challenges, such as achieving relatively light payloads for such systems. In summary, current approaches are not necessarily as accurate as may be desired and/or may be logistically difficult to implement depending at least in part on the situation and/or environment for the objects of interest.

As discussed herein, morphometry refers to the quantitative measurement and/or analysis of the shape, size, and/or dimensions of objects. Morphometry involves precise measurements and/or analysis to better understand the form and/or structure of objects, whether they are biological or non-biological in nature. Many objects, both living and non-living, in the real world have complex geometries and morphologies, making morphometry a non-trivial exercise.

Although claimed subject matter is not intended to be limited in scope in this respect, a non-limiting illustrative example of aquaculture and/or agriculture morphometric measurement may involve collecting and analyzing specific sensor measurements related to the size, shape, and/or physical attributes of living creatures, such as aquatic life or livestock. Examples of morphometric measurements may include count, length, width, height, girth, mass, and/or other relevant parameters. Particular morphometric measurements of interest may vary with the particular type of object. The scope of morphometric measurements is not limited to a particular set of morphometric measurements. These measurements may be used to draw conclusions, gain insights, and/or make decisions with respect to growth, health, and/or overall condition within a changing environment of an object population that may presently be provided to or for a variety of types of living objects typically included in an object population with respect to the environment. That an object population may include a variety of types of living objects, although perhaps falling into an overall category or class of creatures, for example, for which morphometric measurements may be sought is but one complication in terms of the morphometry of living objects.

A further complication with the morphometry of a potential living creature of interest is that opportunities for observation may occur at a distance, perhaps even distances that may be large relative to the size of the living objects of interest. These living objects (with their complex morphologies) may regularly move freely within an environment, sometimes quickly, and usually along aspects and/or directions that are not perpendicular or orthogonal to the view of a camera or other observation system.

It is noted here that to move freely within an environment or about a scene refers to relative motion and/or position between the subject and the sensor, such as a camera. In some examples, a camera comprises one example of a sensor in which the sensor measurements comprise imagery and/or video. Video comprises a sequence of images, and a sensor may not necessarily be fixed or stationary in an environment. Motion of the sensor and motion of a living object of interest (independently or concurrently) may both contribute to uncertainty in sensor measurements. This aspect makes it challenging to generate sufficiently accurate estimates of morphometry. The advent of small unmanned aerial vehicles (UAVs) has enabled aerial measurements which may be used in a variety of systems, including monitoring fisheries, wildlife, aquaculture, agriculture, trees, geologic formations, or humans, to name just a few. However, obtaining sufficiently accurate measurements of living objects remotely has been challenging, but remains desirable.

For example, aquaculture and/or agriculture practitioners can make use of morphometric measurements, if available, such as the number, size, mass, and/or individual or population health status of farmed aquatic life and/or livestock. Morphometric measurements may be used to make decisions about dynamically adapting processes that may affect the animals, such as aquatic life and/or livestock, possibly for better efficiency and/or productivity. However, there is a gap in the availability of technology to enable obtaining sufficiently useful morphometric measurements, such as technology that is reasonably cost-effective, sufficiently accurate, and/or quick while permitting remote sensing to acquire morphometric measurements and/or sensor measurements to make morphometric measurement estimates.

There are a variety of situations in which a morphometric measurement problem and/or challenge may arise. Without intending to limit the scope of claimed subject matter, below are two illustrative examples of challenging environments in which measurement and/or estimation of morphometrics may be both expensive and subject to an undesirable amount of error.

In biological and/or environmental research studying sea-dwelling wildlife populations (e.g., whales), researchers often are unable to get close to their subjects for an extended period. Unoccupied aerial vehicles (UAVs), such as drones, may be used for tracking. These UAVs can return imagery and rough statistics, such as size, but the error in the derived morphometric measurement estimate is often unacceptably high to be sufficiently useful for tracking and/or decision making, for example.

In another example, aquaculture farmers may operate growing environments using varying degrees of control over aquatic life. Water dwelling creatures may have a large degree of freedom of movement, therefore aquaculture farmers face challenges monitoring such creatures for various health parameters, including gathering morphometric measurements and/or morphometric measurement estimates (often to estimate mass, which may, for example, be used to make determinations regarding the adjustment feeding and/or medication schedules). Failure to generate sufficiently accurate estimates of morphometry may impact the financial success of a business, as an example, because uncertainty in mass estimates may have a leveraged impact on yield and/or profitability of a farming operation.

Aquaculture and/or agriculture practitioners seek more accurate morphometric measurements and/or morphometric estimates with respect to number, size, mass, health status, etc. of farmed populations to inform strategic and/or tactical decisions in connection with operations that permit balancing costs with profits and/or natural resources, for example. Yields of such operations, unfortunately, may differ due at least in part to unacceptably inaccurate morphometric measurement estimates leading to unacceptably inaccurate assessments with respect to an object population of varying types of living objects, for example.

Yet another complication to this challenging situation relates to the example of studying whale or fish populations from the air. Observations are taken from above the water, while the living subjects (or living objects of interest) are below the surface of the water, referred to here as obtaining sensor measurements across mediums. Ability to obtain sensor measurements which may be used to generate morphometric measurement estimates, remotely and/or dynamically, may provide a variety of benefits in terms of monitoring population status of wild animals, livestock, or aquatic life including the ability to determine changes in the physical status of object populations that may then be used guide human responses to such changes in terms of care and/or management of the object population.

Light detection and ranging (LIDAR) systems have also been used but are typically quite expensive and may employ large UAVs or planes due at least in part to payload, which may also be costly. Monocular systems may employ a high-resolution camera and altimeter which are also quite expensive with less than adequate results. Current state of the art systems in precision aquaculture include in situ sensors permitting remote sensing to obtain measurements. However, remotely obtaining sufficiently accurate measurements to be used to estimate body size and/or condition are challenging, especially for the size range of much aquatic life in the wild or reared in aquaculture facilities, which may be from a scale that is on the order of a centimeter to a scale that is on the order of several meters or more. Current systems for in situ remote measurements are often not sufficiently accurate by using single camera systems and/or more costly by using complex high end camera systems. Furthermore, such complex systems may be difficult for a typical aquaculture facility to purchase and maintain and may require sophisticated training and/or skilled technicians to operate and process remotely obtained sensor measurements to produce estimates of morphometry.

To summarize, here are at least some of the challenges for morphometry using state of the art systems:
(a) estimating the morphometry, including mass, of individual living objects moving freely about a scene, including if many living objects are within the scene;
(b) accommodating many different “poses” (e.g., changes in position and/or stance) that one or more living objects of interest may take relative to a camera view while still generating adequate morphometric measurement estimates, especially in situations in which the living objects of interest are not perpendicular or orthogonal to the camera and are in sizable groups in the camera view or scene;
(c) addressing the challenge of obtaining sufficiently accurate morphometric measurement estimates from observations made from the air, on the ground, underwater and/or across different mediums;
(d) classifying those living objects into different types, such as within an object population;
(e) representing the morphometry of those different types collectively in addition to individually;
(f) in a collective of such living object types, acquiring object population statistics (e.g., health, life-cycle stage) about each type of living object using morphometrics; and/or
(g) for a system able to address at least some of these measurement and/or estimation challenges, having that system be of moderate cost and/or complexity so that facilities can afford the cost of such systems and are able to operate and maintain such systems without employing technical operators highly trained and/or skilled in sophisticated technology.

In accordance with an illustrative example of claimed subject matter, an apparatus may comprise at least one physical support platform, at least one sensor array including at least one stereoscopic camera, and at least one computing device comprising at least one processor and at least one non-transitory storage medium. In this context, one stereoscopic camera may be understood to refer to a pair of monocular cameras. The at least one non-transitory storage medium may include stored executable instructions such that executing the instructions by the at least one processor may result in: processing sensor measurements including captured images, from the at least one sensor array via a three-dimensional pose estimation model to produce substantially view-invariant morphometric measurement estimates of objects, such as living objects of interest.

In this context, the term substantially view invariant refers to the ability to identify the object, such as a living creature, and generate reasonably accurate estimates of morphometric measurements for the living object despite changes in optical view, position and/or stance of the living object relative to the sensors, such as a camera, depending at least in part on a variety of factors, including distance between the sensor(s) and the living object(s), size of the living object(s), and/or the particular environment, such as under water, airborne on the ground, or in groups, to name a few examples. In at least one example, a camera comprises one example of a sensor in which the sensor measurements comprise captured imagery and/or video. Hence, the at least one sensor array may be referred to as an optical sensor array, such as an optical multisensor array, as an example, without loss of generality. Video comprises a sequence of images. Furthermore, terms like reasonably accurate and/or reasonably consistent used with respect to being substantially view invariant suggests that a morphometric measurement estimate is at least within a few percent of a true morphometric measurement, taken, for example, in a controlled setting with a contact measuring device, such as a vernier caliper.

The claimed subject matter is not intended to be limited to examples provided for purposes of illustration, such as the foregoing. For example, executing the instructions to result in processing sensor measurements may comprise executing instructions to transport sensor measurements collected by a platform to an external system to perform the sensor measurement processing. Here the term “external system” refers to a system, such as a computing device, external to the platform support structure used for collecting sensor measurements that includes a sensor array but is not intended to suggest that the term external system refers to a system external to an embodiment of claimed subject matter. In at least one embodiment, the external system may include a capability to estimate the morphometry of objects, such as living creatures, that are able to move freely about a scene. This illustrative example may use a trained artificial intelligence model, such as a trained machine learning process, to integrate field sensing, via received or acquired sensor measurements, with a pose estimation model implemented by the external system to produce reasonably accurate estimates of living object morphometric measurement estimates.

In this context, the term three-dimensional pose estimation model refers to the use of artificial intelligence to map identified points in three dimensions from an object pose, such as with respect to a particular object view that is relative to a sensor, such as a camera, to corresponding points in three dimensions suitable for making acceptable morphometric measurement estimates of the object. Furthermore, in an example embodiment, morphometric measurement estimates resulting from processed sensor measurements may be provided to an object population assessment, analysis, and/or prediction tool to produce a system level estimate of mass and/or to predict trends in object population status, such as projected health, growth, demographics, etc. The object population assessment, analysis, and/or prediction tool may report its estimates and/or predictions to an end user.

The physical platform may comprise a fixed or a movable physical platform. As suggested, a movable physical platform may comprise a UAV. However, claimed subject matter is intended to cover other examples of movable platforms, such as ground based movable platforms and/or movable platforms able to operate and/or navigate in and/or under water, such as for aquaculture.

Another embodiment may include at least one computing device, such as an external system, external to the physical platform that includes the optical sensor array and its own on-board computing device. The external system may include at least one computing device comprising at least one processor and at least one non-transitory storage medium. The at least one non-transitory storage medium may include executable instructions stored thereon. Executing the instructions by the at least one processor may result in: processing sensor measurements, including images from the optical sensor array of at least one object, with a three-dimensional pose estimation model to produce at least one substantially view-invariant morphometric measurement estimate of at least one object.

As suggested, a three-dimensional pose estimation model may include a trained machine learning process to produce substantially view-invariant morphometric measurement estimates of living objects. In an illustrative embodiment, a trained machine learning process may include any suitable artificial intelligence process, a computer vision algorithm, and/or a trained convolutional neural network process (CNN), such as a trained deep convolutional neural network (DCNN) process. Here, machine learning is not limited to CNN and/or DCNN. Machine learning refers to a variety of artificial intelligence techniques typically employed in classification of measurements, such as labeling of sensor measurements. Any suitable machine learning process or artificial intelligence process may be used herein.

For example, supervised machine learning (SML) may comprise a technique for machine learning (ML). Typically, one or more sample measurements may be made from a test population of measurements. Supervision may refer to the use of an expert and/or other approach for verification with respect to a test population, e.g., a validation of classification of a training sample measurement. Operation of a computing device may take place to process and/or classify sample measurements, such as stored in a computing device memory, with the aid of test sample measurements, also stored in the computing device memory, for example. A machine, such as a computing device, may execute computer instructions, such that a training class may be assigned, referenced, or otherwise associated, etc., with sample measurements from a test population. In SML, training class sample measurements may be employed to classify another sample measurement not included in the sample measurements used for training. Standard machine learning, such as Support Vector Machine (SVM) Learning, is well-known and need not be described in further detail.

Tree-structured classifiers also have been formulated, e.g., by using a sequential and/or serial process of evaluating measurement components. These may be well suited if training class sample measurements comprise a non-standard structure of variable dimension and/or a mixture of sample measurement types. Other methods may employ parallel processing of measurement components, and in at least one embodiment, may employ a fixed and/or reduced dimensional structure.

Another technique to improve accuracy may use sets of machine learning classifiers to generate a lower error by some combination, averaging and/or consensus. For example, tree classifier approaches may have relatively high variance. This may be due at least in part to their hierarchical nature. However, a tree ensemble classifier approach, such as bootstrap aggregation (bagging), may average multiple trees and, as a result, may reduce variance. If training classes are limited to sample replication by stochastic selection without replacement, bootstrapping may comprise a useful method. However, if a learning (e.g., training) set is not sufficiently perturbed, accuracy may not be sufficiently improved. A stochastic forest comprises a collection of tree-like classifiers such that a tree may, cast one or more votes for a class. A stochastic forest approach may improve bagging in some cases, such as by reducing correlation between sampled trees. Other ensemble learning techniques may attempt to combine the strengths of simpler base approaches. Boosting, for example, may use weighted sums of weak machine learning classifiers, which may evolve to a more accurate composite predictor and/or committee machine learning classifier. However, some boosting processes may be sensitive to stochastic classification noise.

Neural networks, such as CNN and/or DCNN described in more detail later, may employ nonlinear operations to transform sample measurements, such as sample sensor measurements, and may be useful for some problems having a relatively high signal-to-noise ratio and/or applications where prediction without an associated interpretation may be acceptable. Approaches, such as multiple layers of operations and/or training processes, e.g., back-propagation, may be employed. Here, an application specific neural network architecture may be generated at least partly due to complexity, as described in more detail later.

In an illustrative embodiment, an optical sensor array, which may include at least one stereoscopic camera, may also include additional sensors, to measure temperature, pressure, humidity, and/or altitude. Executing stored instructions may result in processing the captured sensor measurements, including captured images and other sensor measurements, via a three-dimensional pose estimation model to produce substantially view-invariant morphometric measurement estimates with respect to living objects of interest.

Processing captured sensor measurements, in at least one embodiment, may include calibrating and/or correcting the sensor measurements. Processing of images, which comprise sensor measurements for the optical sensor array, may include image rectification and/or image triangulation, in at least one embodiment. More details about calibration and/or correction of sensor measurements, image rectification, and image triangulation are provided below.

In at least one example, morphometric estimates resulting from processed sensor measurements may be provided to an object population assessment, analysis, and/or prediction tool to produce a system level estimate of mass and/or to predict trends in object population status, such as health, growth, food consumption, etc. For example, processing the captured images along with the additional sensor measurements may comprise employing a developed and validated statistical model to estimate and predict mass, such as biomass, for multiple living objects, including multiple types of living objects of an object population.

Here, the term “object population” refers to an overarching class and/or category of objects, living or non-living, which are the object of study. Examples may include aquatic life, such as categories of aquatic wildlife (e.g., whales, dolphins, fish, and/or combinations thereof), aquatic livestock (e.g., salmon, oyster), and/or specific categories of livestock, (e.g., cattle, horses, bulls, llamas, sheep, and/or combinations thereof), etc. More details about developing and validating a statistical model for use in an object population assessment, analysis, and/or prediction tool are provided below.

Reference is made in the following detailed description to accompanying drawings, which form a part hereof, wherein like numerals may designate like parts throughout that are corresponding and/or analogous. Figures have not necessarily been drawn to scale for simplicity and/or clarity of illustration. For example, dimensions of some aspects may be exaggerated relative to others. Furthermore, structural and/or other changes may be made without departing from claimed subject matter. It should also be noted that directions and/or references, for example, such as up, down, top, bottom, and so on, may be used to facilitate discussion of drawings and are not intended to restrict application of claimed subject matter. Therefore, the following detailed description is not to be taken to limit claimed subject matter and/or equivalents. Rather, it is to be understood that other examples and/or embodiments are contemplated and may be utilized. Also, examples and/or embodiments have been provided of claimed subject matter herein and it is noted that, as such, those illustrative examples and/or embodiments are inventive and/or unconventional; however, claimed subject matter is not necessarily limited to examples and/or embodiments provided primarily for illustrative purposes. While advantages have been described in connection with illustrative examples and/or embodiments, claimed subject matter is inventive and/or unconventional for additional reasons not expressly mentioned in connection with those examples and/or embodiments. In addition, references throughout this specification to “claimed subject matter” refer to subject matter intended to be covered by one or more claims and are not necessarily intended to refer to a complete claim set, to a particular combination of claim sets (e.g., method claims, apparatus claims, etc.), and/or to only a particular claim. Furthermore, “in this context” refers to in the context of the present patent application.

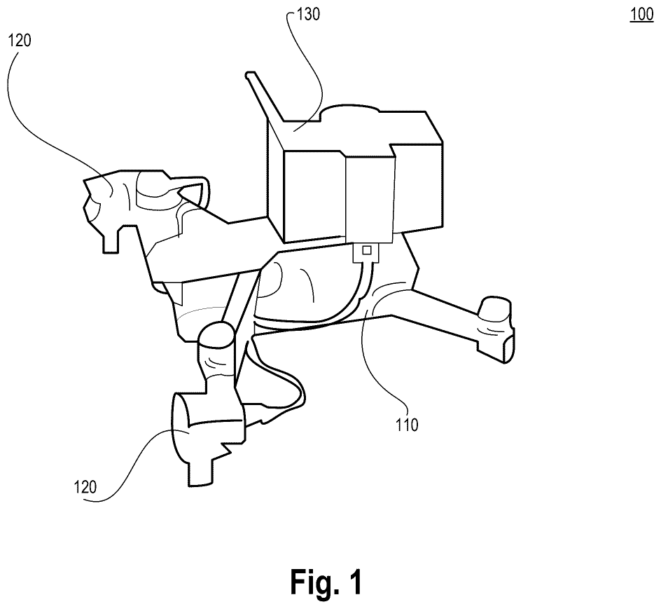

FIG. 1 illustrates an embodiment 100 of an apparatus in accordance with claimed subject matter. For example, embodiment 100 includes a physical support structure, such as physical support platform 130. In this example, the optical sensor array comprises a stereoscopic camera system (e.g., two cameras) 120. Claimed subject matter is not limited to an optical sensor array that comprises a stereoscopic camera system. An optical sensor array may comprise a LiDAR device. Here, the term LiDAR refers to an optical remote sensing technology that irradiates a target with a beam of light, usually a pulsed laser. In at least one embodiment, FIG. 1 includes computing device 110. Embodiment 100 may be referred to as a sensor processing unit (SPU) without loss of generality.

In at least one embodiment, multiple payloads, such as with respect to multiple physical platforms, may be employed. In at least one embodiment, an optical sensor array including one camera of a stereoscopic system (e.g., two cameras 120) may comprise a first payload integrated into a first physical platform, such as 130. A computing device substantially similar to computing device 110 but physically separate may comprise a second payload (perhaps for a second physical platform, that may also include a second optical sensor array including another camera of a stereoscope system (e.g., two cameras 120), in at least one embodiment. Such an approach may provide logistical advantages in terms of reducing respective payloads. The first platform may, for example, comprise a movable platform (with a single camera payload), while the second platform may comprise a fixed platform (with a second single camera payload and a computing device) creating a stereoscopic camera system that may comprise two platforms, in at least one embodiment. Other systems may comprise multiple platforms and/or the respective multiple platforms may respectively comprise a single camera payload with at least one including a computing device. As is the case with stereophotogrammetry, having an estimate of distance between sensors at the time sensor measurement are recorded is desirable.

In an example, a wireless link, such as a wireless communication channel, may permit sensor measurements to be passed between optical sensor arrays and the computing device, creating a mesh network. In such an example, computing device 110 may perform collection and initial processing of sensor measurements, such as correction and/or calibration before transport to an external system for further, more complex processing, such as previously described. Computing device 110 may be referred to as a sensor processing unit (SPU), in this context.

As suggested previously, physical support structure or platform 130 may be movable or fixed, although in the illustrative embodiment of FIG. 1, platform 130 is shown as movable. In some embodiments, platform 130 may comprise a UAV Platform 130 may be manually and/or autonomously piloted. In at least one example, platform 130 may be fixed, without loss of generality, to a piece of wood mounted to a flagpole. Platform 130, in an illustrative embodiment, is to at least partially facilitate orientation, positioning, and/or to provide a mounting structure for the sensory array in relation to the environment. A second platform, if utilized, may at least partially facilitate orientation, positioning, and/or provide a mounting structure, in at least one embodiment.

In an example embodiment, a system may remotely measure objects, such as living objects, from a variety of platforms (e.g., fixed mount and/or moveable) within and/or across mediums, from the air, through the water, and across mediums. An embodiment may also employ an optical sensor array that includes a multi-camera array system that implements multi-view stereovision (e.g., multi-stereoscopic cameras), a variety of possible mounting structures, and signal processing of sensor measurements implemented via executable software instructions stored on a computing device included as part of the apparatus integrated with the mounting structure. For example, the executable instructions may perform sensor measurement collection, sensor measurement calibration, and/or correction processing, and transport of processed sensor measurements to an external system for more complex sensor measurement processing, including image rectification, image triangulation, and machine learning processes to detect objects of interest, such as living objects, within a field of view using possible captured poses to make estimates of morphometric measurements. Estimated morphometric measurements may then be combined as part of the sensor measurement processing to predict object mass using object specific morphometric-mass statistical relationships, in at least one embodiment. Sensor measurement detection, collection, and processing may all be performed on a single platform that includes an optical sensor array and at least one computing device, including stored instructions capable of performing these operations if executed, in at least one embodiment.

In an embodiment, some sensors (e.g., cameras) may record imagery of objects on land, ground, or underwater. Other sensors remotely and concurrently may collect environmental measurements including, but not limited to, temperature, humidity, pressure, and/or proximity, such as proximity to the sensors recording imagery, for example. In an embodiment, a system may also include housing to protect the electronics from water damage if gathering sensor measurements under water and/or may be relatively lightweight for use if gathering airborne sensor measurements. Although computing device 110, as suggested above and described in more detail below, may perform collection and initial processing of sensor measurements, it may also potentially execute other tasks related to its environment, such as controlling motion of a movable platform or UAV, for example.

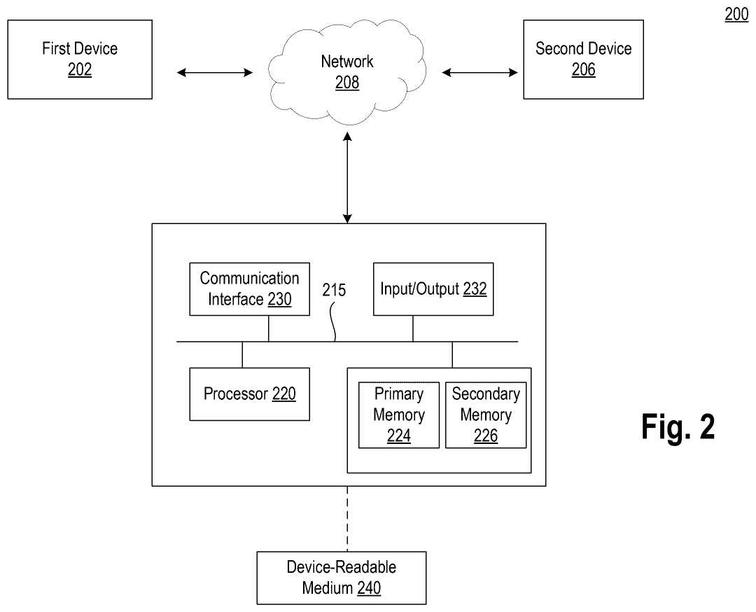

FIG. 2 illustrates an embodiment of a computing device, such as first computing device 202, second computing device 204 and third computing device 206. In at least one example, second computing device 204 may operate as a sensor processing unit (SPU). In at least one example, second computing device 204 may be part of a platform support structure that includes a sensor system or second computing device may be physically separate and receive sensor measurements wirelessly, in an embodiment, via communication interface 203. Computing device 204 may also communicate with one or more external systems, such as via communication interface 230. An external system may comprise a local computer, a server cluster, and/or any other device capable of more complex processing of sensor measurements, as previously described and as described in more detail later. In FIG. 2, computing devices 202 and 206 are illustrated as examples of external systems.

In general, communications between an optical sensor array and a sensor processing unit may take place using a variety of methods, such as wired, through a direct or indirect wired connection, or wirelessly via a local network, via telecommunications, or via a satellite, etc. Communications between a sensor processing unit and an external system may also take place using various wireless communication approaches, discussed in more detail later. For example, the first, second, and third computing devices, along with network 208, as shown in FIG. 2, may form an embodiment 200 of a computing and communications network, such as a mesh network. Furthermore, in some embodiments, these illustrations of computing devices may further comprise features of a client computing device and/or a server computing device. Here, the term “computing device” whether employed as a client and as a server, or otherwise, refers at least to a processor and a memory connected by a communication bus.

Referring to FIG. 2, computing device 204 comprises at least a processor 220, a memory 222, and a bus 215. Here, a “processor” connotes a specific structure, such as a central processing unit (CPU) of a computing device which may include a control unit and an execution unit, although other types of processors may likewise be employed, such as a digital signal processor (DSP), a graphics processing unit (GPU), an artificial intelligence (AI) processor, an acceleration processing unit (APU), a microcontroller, another type of specialized processing unit, and including combinations of any of the foregoing. In an embodiment, a processor may simply comprise a device that executes instructions to process input signals to provide output signals.

Other aspects of illustrative computing device 204 are described in more detail below. Memory 222 of device 204 may provide one or more sources of executable instructions, such as computer instructions, in the form of physical states and/or signals (e.g., stored as memory states), for example. Computing device 202 may communicate with computing device 204 by way of a network connection, such as via network 208, for example. A network connection in the context of network 208 while physical, typically may not necessarily be tangible, such as a wireless connection (in comparison to a wired connection, for example). Although computing device 204 of FIG. 2 shows various tangible, physical components, claimed subject matter is not limited to a computing device having only these tangible components as other implementations and/or embodiments may include alternative arrangements that may comprise additional tangible components or fewer tangible components, that may function differently while achieving similar results.

Memory 222 may comprise any non-transitory storage mechanism. Memory 222 may comprise, primary memory 224 and secondary memory 226, additional memory circuits, mechanisms, or combinations thereof. Memory 222 may comprise random access memory, read-only memory, etc., such as in the form of one or more storage devices and/or systems, such as a disk drive including an optical disc drive, a tape drive, a solid-state memory drive, etc.

Memory 222 may be utilized to store a program of executable instructions, such as executable computer instructions. For example, processor 220 may fetch executable instructions from memory and proceed to execute the fetched instructions. Memory 222 may also comprise a memory controller for accessing device readable medium 240 that may carry and/or make accessible digital content, which may include code, and/or instructions executable by processor 220 and/or some other device, such as a controller, capable of executing instructions, such as computer instructions. Under direction of processor 220, a non-transitory memory, such as memory cells storing physical states (e.g., memory states), comprising a program of executable instructions, may be executed by processor 220 and able to generate signals to be communicated via a network, such as network 208, for example. Generated signals may also be stored in memory as physical memory states.

For example, a computing device, such as computing device 204, may include executable instructions stored on one or more memories. In at least one example, executing instructions by one or more processors of computing device, such as computing device 204, that may be coupled to one or more memories, such as memory 222, may result in performance of a method, such as a method of collecting, performing initial processing sensor measurements, and transport of initially processed sensor measurements to an external system, such as computing device 202 and/or 206, as previously discussed. In an embodiment involving an external system, computing device 202 and/or 206, may also comprise executable instructions that may communicate processed sensor measurements to a remote or separate display, such as via a wired or a wireless connection to a display, for viewing by an end user. For example, various peripherals, such as a display, may be included in computing and communications network embodiment 200.

Communication bus 215 may transfer signals between various components shown in FIG. 2 as part of computing device 204. Such signals and/or device operations may substantially comply with and/or be substantially compatible with a variety of different bus architectures, such as ISA (Instruction Set Architecture), PCI (Peripheral Component Interconnect), AGP (Accelerated Graphics Port), USB (Universal Serial Bus) and/or others where appropriate. The foregoing, and hence, claimed subject matter, is intended to include any version of these bus architectures, now known and/or to be later developed. In an embodiment, an apparatus such as embodiment 100 may be used to remotely collect sensor measurements with respect to a population of living creatures, including, livestock or aquatic life, such as from at least one stereoscopic camera and from additional sensors. Processing may be implemented to aid the quality of sensor measurements obtained. In an embodiment, calibration and/or correction of sensor measurements may take place.

Quality calibration and/or correction for a multi-sensor array, for example, is desirable and is achieved, using at least in part, image processing methodologies following established procedures, such as described in Harvey et al., “A system for stereo-video measurement of sub-tidal organisms,” appearing in Marine Technology Society Journal 29:10-22 (1996); and in Harvey al., “Calibration stability of an underwater stereo-video system: Implications for measurement accuracy and precision,” appearing in Mar Technol Soc J 32:3-17 (1998). If measuring objects across media, e.g., from the air or underwater, it may be desirable to conduct calibration for the dominant medium of the media, that is, the medium that includes or will include most of the distance from the sensor or sensors to the object. However, if measuring objects underwater while they are within the water, then conduct the calibration wholly underwater, and if measuring objects on the land through the air, or in the air through the air, then conduct the calibration wholly in air, etc.

In such a process, as an example, a pattern of known dimensions and proportions may be shown to the sensors individually and collectively. Sensor optical characteristics and relative positions, for example, may be calculated from a visible pattern using marker identification and correction techniques, such as techniques referenced in Zhang, “A Flexible New Technique for Camera Calibration,” in IEEE Transactions on Pattern Analysis and Machine Intelligence. 22, no. 11 (November 2000): 1330-34. https://doi.org/10.1109/34.888718; Heikkila et al., “A Four-step Camera Calibration Procedure with Implicit Image Correction,” in Proceedings of IEEE Computer Society Conference on Computer Vision and Pattern Recognition, 1106-12. San Juan, Puerto Rico: IEEE Comput. Soc, 1997. https://doi.org/10.1109/CVPR.1997.609468, or U.S. Pat. No. 11,295,478, titled “Stereo camera calibration method and image processing device for stereo camera,” by Junichi Mori issued Apr. 5, 2022, as examples. Since sensor measurements may include temperature readings such as humidity, etc., these measurements may also be calibrated and/or corrected to more accurately capture the environment, as appropriate. In one embodiment, processing of sensor measurements for calibration and/or correction may take place before additional more complex processing, although claimed subject matter is not intended to be limited to illustrations. In at least one embodiment, if such calibration and/or correction processing is implemented, it may also take place somewhere else in an overall process.

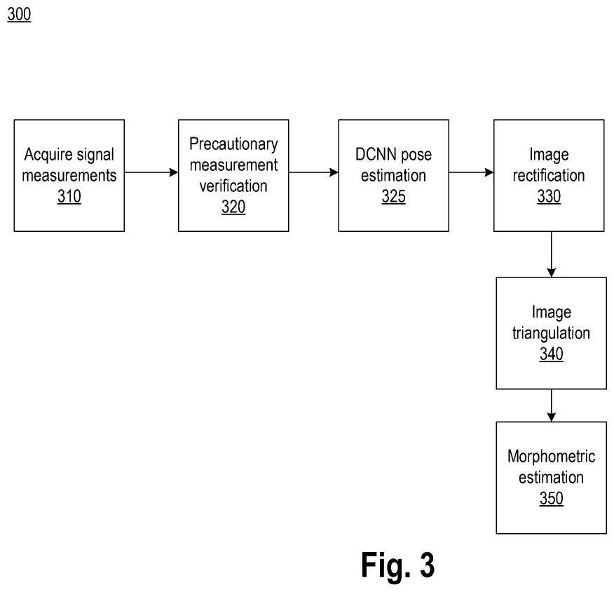

FIG. 3 is a flow diagram illustrating an embodiment 300 of further, potentially more complex, processing of sensor measurements in accordance with claimed subject matter, such as may be implemented by computing devices 202 and/or 206. The process embodiment illustrated may be employed to combine image rectification, image triangulation, and machine learning processes to calculate morphometric estimates of an object, such as a living object. Hence, an embodiment in accordance with claimed subject matter, which may include computing device 204 and a system external to computing device 204, such as computing devices 202 and 206, which may be used to accomplish sensor measurement collection, point detection, image rectification, and image triangulation to produce a reasonably accurate morphometric estimate from pre-trained machine learning processes. Claimed subject matter is not limited in scope to this example embodiment. In other embodiments, similar processes may be implemented in a different order, may include additional processing, and/or may omit at least some of the processing described. Different aspects of processing may be implemented using a different architecture of communicating computing devices.

Block 310, for this example, receives or acquires sensor measurements which may be preliminarily evaluated to determine if the received or acquired sensor measurements are such that a reliable prediction could be produced using such measurements, shown as block 320. The evaluation process may include multiple verifications, also illustrated, such as an object detection process that may not be overly computationally intensive, an exposure level check and/or other similar precautionary checks regarding sensor measurement integrity, for an embodiment.

A pre-trained deep learning model, such as a DCNN, pose estimation process may detect an identity and pose for a target object, as shown by block 325. In an embodiment, a DCNN process may label identified points, such as in the imagery, using labels derived from a process for training the DCNN. A DCNN is a type of CNN. CNNs and DCNNs are reasonably well understood and do not require extensive elaboration.

A convolutional neural network (CNN) is a regularized type of feed-forward neural network that “learns” features via filters and/or kernel processing. A convolutional neural network architecture includes an input layer, hidden layers, and an output layer. In a convolutional neural network, the hidden layers include one or more layers that perform convolutions. Typically, this includes a layer that performs a dot product of the convolution kernel with the input matrix of a layer. This dot product is usually the Frobenius inner product, and its activation function is commonly a rectified unit activation function. As the convolution kernel slides along the input matrix for the layer, the convolution operation generates a feature map, which in turn contributes to the input of the next layer. This is followed by other layers such as pooling layers, fully connected layers, and normalization layers.

“Deep” in DCNN refers to a CNN that has a multiple number of, or even many, hidden layers. See Aloysius et al., “A review of deep convolutional networks,” International Conference on Communication and Signal Processing, April 2017, India; and Ali et al., “Performance Evaluation of Deep CNN-Based Crack Detection and Localization Techniques for Concrete Structures” in Sensors 2021, 21, 1688. An architecture referred to as ResNet50, a 50-layer DCNN, is reasonably popular in the scientific community, readily accessible and may be used in at least one embodiment. See He et al., “Deep Residual Learning for Image Recognition,”, Microsoft Research, December 2015, available at https://doi.org/10.48550/arXiv.1512.03385.

A pose of an object may be image rectified, as shown by block 330, such as to handle camera lens distortion and then image triangulated into three-dimensional coordinates, as shown by block 340. These techniques are also reasonably well known and do not require extensive elaboration. Image rectification refers to a transformation process typically used to rectify differences between separate images, such as produced by a stereoscopic camera system, for example. Image rectification is typically used in camera stereovision to locate matching points between images. Of course, claimed subject matter is not limited to an illustrative embodiment employing image rectification. As one example, an image undistortion process may be employed instead. In this context, an image undistortion process refers to a process that maps the coordinates of an output undistorted image to an input camera image by using distortion coefficients. As an illustration, an intrinsic matrix and distortion coefficients may be specified that describe the image distortion to be corrected. The intrinsic matrix may, for example, comprise the focal length, the optical center (also known as the principal point), and the skew coefficient. The distortion coefficients may, therefore, model radial and tangential distortions, for example.

Image triangulation refers to a process of determining a point in three-dimensional space given its projection onto two or more images. A camera projection function from three dimensions to two dimensions for the camera(s) involved is used and may be represented by camera matrices. Since a point in an image corresponds to a line in three-dimensional space, points on the line in three dimensions may be projected to the point in the image. If a pair of corresponding points in two or more images can be found, it follows that they are the projection of a common three-dimensional point because the set of lines generated by the image points should intersect at that three-dimensional point, in at least one embodiment. The trigonometric formulation of the coordinates of that three-dimensional point may be computed in a variety of ways. With reasonably accurate three-dimensional coordinates, reasonably accurate morphometric measurement estimates may then be calculated, as shown by block 350. Examples of measurements, such as some morphometric measurements, may include type, count, length, width, height, girth, shape, area, mass, etc.

In an embodiment, training with respect to machine learning processes may be performed so that object population specific and site-specific related processing may be executed by computing device 202 or computing device 206, as examples. Thus, embodiments may comprise custom trained machine learning processes with respect to a variety of object populations of types of living objects and a variety of site-specific environments. Thus, an embodiment may include multiple pre-trained object population specific and site-specific related processing capable of being executed by computing device 202 or 206, for example, in which, in an embodiment, a user may select the particular object population specific and site-specific processing to employ for a given set of sensor measurements.

As mentioned, although a variety of types of machine learning approaches may be employed, as an illustration, deep convolutional neural network (DCNN) processing may be used. In at least one embodiment, training of a DCNN for a three-dimensional pose estimation model involves a machine learning training process to select (e.g., label) measurement points for a variety of poses with respect to an object population to produce a variety of desired morphometric measurements. For example, a DCNN process may be trained on image frames that are manually labeled. In at least one example, a type of three-dimensional pose estimation model may comprise a markerless pose estimation process in which positions of specific points within video frames may be estimated without physical markers or labels. In at least one embodiment, smoothing and/or point filtering may be employed. Machine learning in connection with artificial intelligence is well understood and does not require additional elaboration other than as previously provided. See for example, Michalski et al. (Ed), “Machine Learning: An Artificial Intelligence Approach,” TIOGA Publishing Co., Palo Alto, California, 1983.

As a result, the DCNN may be trained to identify, for example, living objects of different types (e.g., unique species, age classes, genders, etc., that are identifiable from outward physical traits) as part of an object population. Furthermore, labeled points may be generated in a DCNN training process for use in obtaining a variety of morphometric measurements that correspond with selected labeled pose points of various living objects of the object population. These sets of corresponding labeled points may be provided as so called “ground truth” to train the DCNN process. Training includes providing labels to identifiable points within sensor measurements from which the DCNN may “learn” to generate labeled points used to produce desired morphometric measurement estimates, in at least one embodiment.

As previously suggested, alternative machine learning processes may be used in place of a DCNN, for example, to detect the pose of a living object and generate morphometric measurement estimates for the living object from sensor measurements, as described. However, it is noted that a similar type of model training process may be conducted with respect to such alternative machine learning processes. Typically, training employs a large amount of sensor measurements to train a model so that the model can be used to obtain reasonably reliable morphometric measurement estimates, as desired.

In at least one example, separate and apart from training a DCNN, a statistical model may be formulated and validated to calculate specific physical attributes, including mass estimates of a variety of types of living objects included within an object population and produce status predictions, as examples, for such object populations, such as livestock and/or aquatic life. Such a statistical model, after validation, may be employed in an object population assessment, analysis and/or prediction tool, as previously suggested. In at least one embodiment, such a statistical model, like the previously described training, may be developed to be site and/or object population specific due at least in part to the complexities associated with relating morphometric measurement estimates to mass estimates, for example. Such a statistical model may consequently be validated using manually collected mass measurements in an embodiment. Morphometry-physical attribute relationships (e.g., mass relationships) may vary across species, populations, regions, and/or specific facilities such that establishing a site-and/or object-population specific suite of statistical models may assist in determining a more accurate object population assessment. As with DCNN training for at least one embodiment, a formulated and validated statistical model may also be custom generated with respect to specific sites and/or specific object populations. While such machine learning model training and statistical model validation may be custom generated, it is nonetheless reasonably flexible in that it may be employed with a wide range of potential object populations and a wide range of potential site environments. Hence, as suggested, an embodiment may include multiple pre-trained object population specific and site-specific related processing capable of being executed by computing device 202 or 206, for example, in which, in an embodiment, a user may select the particular object population specific and site-specific processing to employ for a given set of sensor measurements.

Initial validation may be conducted to determine object population-specific relationships between mass, for example, and morphometrics by manually measuring mass of a sample of the types of living objects of an object population, as suggested. Site environment specific computational errors may also be estimated by comparing the manual measurements with statistically generated mass estimates.

In at least one example, manually collected morphometric measurements taken, in a controlled setting with a contact measuring device, such as a vernier caliper, for example, which may include mass, length, area, etc., may be input into a model fitting process that uses statistical diagnostic procedures to select one or more statistical models using statistical model fitting diagnostics. In at least one example, to create a statistical model from which to predict mass from remotely sensed morphometrics, it is desirable to manually measure mass across a sample of individual living objects from an object population, although morphometric predictors may be measured remotely or manually.

Any one of a variety of potential statistical models may result from a range of known statistical model types used for estimation and/or prediction of multiple types of multiple living objects from an object population, in at least one embodiment. As illustrative examples, software, such as R (v. 4.1.2) available from R Foundation for Statistical Computing & R Studio (v. 2021.09.2) available from Posit Software, PBC, may be used. Using such software, for example, model adjustments using the Akaike Information Criterion correction for small sample sizes (AICc) may be made. The Akaike information criterion (AIC) is, in general, an estimator of prediction error that accounts for both model fit to the sensor measurements and model parsimony, and thereby provides a measure of relative quality of a statistical model for a given set of sensor measurements. However, for a sample size that is relatively small, there is a substantial probability that AIC will select models that have too many statistical predictors, i.e., that AIC will overfit the statistical model. To address such potential overfitting, AICc was developed, and is AIC with a correction for small sample sizes.

A selected statistical model type may be used to estimate mass against a set of potential morphometric predictors to judge performance, in at least one embodiment. Predictor collinearity may be assessed, and/or potential predictor variables that cannot co-occur in a candidate model may be determined, in at least one embodiment. Statistical model selection may include selection of a statistical model type and/or selection of possible morphometric predictors.

At this point, for an embodiment, a selected statistical model may be evaluated using various combinations of potential predictors (e.g., manually collected morphometric measurements). Using manually collected morphometric measurements, including mass, for various types of living objects of an object population as a basis for comparison. Types of living objects may include different species, different sexes, and/or different places in a life cycle, such as children and/or parents of living objects, for example. The statistical model using the different morphometric predictors may be assembled to estimate mass (for example, or to estimate other object size morphometric measurements of the object population) resulting in a determination and validation of the selected statistical model to be used for object population assessment, analysis and/or prediction. Notably, some different combinations of morphometric measurement predictors in this illustrative example may perform equivalently to predicted mass estimates for an object population, such that the estimation errors are within an a priori acceptable range (e.g., ±5% error or less).

In that situation, a set of multiple statistical models may exist that use different combinations of morphometric measurements to acceptably estimate mass. This may be desirable for situations in which not all types of morphometric measurement estimates may necessarily be calculated from available sensor measurements. This, in effect, leverages whichever morphometric measurement estimates can be obtained to then calculate an estimate of mass. Furthermore, predictions, such as for a particular type of living object, generated from different sets of morphometric estimates may be averaged to produce a combined estimate of mass and a measure of uncertainty about the estimate. In at least one example, a validated statistical model set using different combinations of morphometric measurement predictors may be used to perform object population assessment, analysis and/or prediction.

To perform object population assessment, analysis and/or prediction, morphometric measurement estimates from having processed sensor measurements, including imagery, may be collected along with other potentially relevant statistical indicators for use in object population assessment, analysis, and/or prediction, such as sampling error from the statistical analysis performed, sampling scheme used with respect to collecting sensor measurements, (e.g., randomized sampling, opportunistic sampling etc.), and/or other potentially explanatory relevant statistical predictors (e.g., sampling strata, temperature, date, time, etc.). Morphometric measurement estimates and other potential statistical predictors, in at least one embodiment, may be used with the statistical model sets to generate mass estimates, such as mass estimates for particular types of living objects. Mass estimates for particular and/or multiple types of living objects may be used within one or more kinds of population models. In at least one embodiment the length, area, and mass estimates can be used to estimate other population-level indicators (e.g., harvest rate, survival rate, somatic growth rates), using several different families of assessment models, such as stock assessment models, dynamic energy budgets models, welfare/health assessment models, etc., depending on the management objectives. The output from these models may then be used to make inferences with respect to an object population, such as health, growth, expected food consumption, etc. Examples of object population and/or similar models for making such inferences are described in Maunder et al., “A Review of Integrated Analysis in Fisheries Stock Assessment,” in Fisheries Research 142 (2013) 61-74; Schnute et al., “A New Approach to Length-Frequency Analysis: Growth Structure” in Canadian Journal of Fisheries and Aquatic Sciences, Vol. 37, No. 9, September 1980; Tschirren et al., “MyFishCheck: A Model to Assess Fish Welfare in Aquaculture,” in Animals 2021, 11, 145; and Yang et al., “A Dynamic Energy Budget Model of Fenneropenaeus chinensis with Applications for Aquaculture and Stock Enhancement,” in Ecological Modelling 431 (2020) 109186. Estimates and/or identified trends generated by an object population assessment, analysis and/or prediction tool may be provided to end users a variety of ways for their review and/or to guide management decisions. In at least one example, results may be uploaded to one or more websites and/or provided to end users via a GUI for further analysis and review.

Typically, after training and statistical model validation, it would be unusual to re-conduct these processes again for a particular site environment and/or a particular object population. However, there may be situations such that doing so may be prudent. Examples may include drastic changes in environmental conditions, a major facility upgrade, changes in some living object types in the object population, etc. However, as previously described with respect to training, likewise with respect to statistical model validation, an embodiment may include multiple pre-trained object population specific and site-specific related processing capable of being executed by computing device 204, for example, in which a user may select the particular object population specific and site-specific processing to employ.

An embodiment may employ various moving or fixed platforms (e.g., UAV, underwater vehicle, rotating boom). For an embodiment that includes a UAV or fixed platform including an optical sensor array that resides above the water and is used to measure living objects below the surface of the water, reasonably accurate morphometric measurement estimates are obtainable using the processing previously described for the sensor measurements despite the presence of water refraction. In at least one example, vibration isolation of a multi-camera system may be employed so an embodiment may include a UAV platform without a significant concern that excessive camera vibration and/or movement may corrupt sensor measurements. An embodiment may include multiple stereoscopic cameras and camera pairs with respect to the stereoscopic cameras may also share a camera. For example, in an embodiment including a three-camera system, cameras 1 and 2, cameras 2 and 3, and cameras 1 and 3 may collect stereo-camera measurements. Embodiments may also be adapted to varying environmental situations. For example, measuring living objects less than about 5 cm in length from about a 3 m distance may suggest a camera focal length and/or camera separation or at least a range thereof. Measuring living objects less than 1 m in length from a 25 m distance may suggest a different camera focal length and/or a different, potentially larger camera separation or at least a range thereof.

An embodiment may use pose estimation to generate morphometric measurement estimates of living objects. An embodiment enables real-time, synchronous or non-synchronous, non-invasive, three-dimensional sensor measurements of object populations of living objects so that estimates and/or assessments of their morphometric characteristics may be generated. In at least one example, a deep convolutional neural network (DCNN) model, such as ResNet50, may be used with any type of object. An embodiment that combines multiple camera views with powerful signal processing techniques, such as described, introduces a useful tool to aquaculture and/or agriculture providing a level of automation not previously available.

In an embodiment that may also employ object population assessment, population analysis, and/or population prediction, users may now be able to better evaluate aspects related to present developing situations that may lead to future potential issues with respect to the object populations of living objects they manage. In an embodiment, model fitting using maximum likelihood and/or similar probabilistic and/or statistical techniques to estimate growth rates, current mass, and/or to predict future mass enables a higher level of management and/or care than previously available. For example, other systems may merely evaluate object population health as a snapshot in time, while here, an embodiment may be used to provide an early warning about potentially disastrous situations that may begin to develop that may require special attention and/or changes in population treatment and/or care.

In an embodiment, additional features that may prove beneficial may be included. For example, optical sensor arrays may be equipped with a zoom feature that may permit gathering performance metrics (e.g., with respect to object population health) over a range of living object sizes, such as from 1 cm to 5 m from a 25 m distance. In at least one example, objects living in water should be less than about 1 m depth from the water surface, or at least visible from the surface, for reasonably accurate sensor measurements made while airborne. In at least one example, camera separation (such as with a pair of cameras to obtain stereoscopic measurements), and distance from an object, may be adjusted to improve estimate accuracy. However, increasing camera separation may detrimentally affect stability for an embodiment that includes a UAV movable platform. During operation to collection sensor measurements, placement of a living object around the center of a field of view may reduce parallax error while placement of a living object on the edge of a field of view may increase parallax error; although stereoscopic cameras are relatively robust to parallax error, especially in relation to a monoscopic camera. In at least one example, stereoscopic camera calibration may comprise a two-dimensional or three-dimensional calibration. Either should provide acceptable accuracy, although three-dimensional calibration tends to improve accuracy.

Although the illustrations provided earlier may suggest an on-board computing device, such as computing device 110, shown in FIG. 1, claimed subject matter is not limited in this respect. For example, in an embodiment that includes a movable UAV platform with an optical sensor array, a computing device may be physically separate, such as a physically separate laptop, etc. A computing device may be part of a fixed or moveable platform, but that is not required.

An embodiment may comprise an article, such as a non-transitory storage medium. The non-transitory storage medium may include executable instructions stored thereon. Furthermore, execution of the stored instructions by a processor may process received or acquired sensor measurements, including images, from at least one optical sensor array. The optical sensor array may typically include at least one stereoscopic camera. In at least one example, the received or acquired sensor measurements may be initial processed to correct and/or calibrate the sensor measurements. The images may be of at least one living object and may be processed with a three-dimensional pose estimation model to produce at least one substantially view-invariant morphometric measurement estimate of the at least one living object. In at least one example, further processing may be used to estimate and/or predict mass with respect to an object population to identify and report trends, etc., for an end user.

In an embodiment, a server may receive or acquire sensor measurements, and as a service, host the sensor measurements and perform high end, complex process of the sensor measurements, via execution of stored instructions on a non-transitory storage medium of the server, to generate a substantially view-invariant morphometric measurement estimate of at least one living object and make it available to an end user. Further processing may be used in an embodiment to estimate and/or predict mass with respect to an object population to identify and report trends, etc., for an end user.

In at least one example, one or more substations located in various environments may receive or acquire sensor measurements, including images, such as via a wireless connection, from a platform that includes an optical sensor array and a computing device to collection sensor measurements, perform initial processing, and transport the initially processed sensor measurements to the one or more substations. The images may be of at least one living object. In at least one example, a substation may store and perform more complex process sensor measurements, including images. In at least one embodiment, the sensor measurements may be processed via execution of stored instructions on a non-transitory storage medium of the substation to generate a substantially view-invariant morphometric measurement estimate of at least one living object making it available to an end user. In at least one embodiment, further processing may be used to estimate and/or predict mass with respect to an object population to identify and report trends, etc., for an end user. In at least one embodiment, collected sensor measurements may be uploaded from a substation that acquired or received the sensor measurements from a platform including an optical sensor array, to an external system, such as a computing device in the cloud, that has a non-transitory storage medium with stored instructions capable of execution to process the sensor measurements. In at least one embodiment, the computing device in the cloud may comprise a server and/or a computing device of an end user.

Here, the terms “connection,” and “component” and/or similar terms are intended to be physical but are not always tangible. Whether or not these terms refer to tangible subject matter may vary in a particular context of usage. A tangible connection and/or tangible connection path may be made, such as by a tangible, electrical connection, such as an electrically conductive path comprising metal or other conductor, that is able to conduct electrical current between two tangible components. A tangible connection path may be at least partially affected and/or controlled, or open or closed, at times resulting from influence of one or more externally derived signals, such as external currents and/or voltages, such as for an electrical switch. Examples of an electrical switch include a transistor, a diode, etc. A “connection” and/or “component,” in a particular context of usage although physical, can also be non-tangible, such as a connection between a client and a server over a network, particularly a wireless network, which generally refers to the ability for the client and server to transmit, receive, and/or exchange communications, as discussed in more detail later.

In a particular context of usage, such as a particular context in which tangible components are being discussed, therefore, the terms “coupled” and “connected” are used in a manner so that the terms are not synonymous. Similar terms may also be used in a way in which a similar intention is exhibited. Thus, “connected” is used to indicate that two or more tangible components and/or the like, for example, are tangibly in direct physical contact. Two tangible components that are electrically connected are physically connected via a tangible electrical connection, as previously discussed. While “coupled,” is also used to mean that potentially two or more tangible components are tangibly in direct physical contact, “coupled” is also used to mean that two or more tangible components and/or the like are not necessarily tangibly in direct physical contact, but are able to co-operate, liaise, and/or interact, such as by being “optically coupled.” The term “coupled” is also understood to mean indirectly connected. Here, the term “physical” at least if used in relation to memory (non-transitory), implies that such memory components and/or memory states are tangible.

Here, a distinction exists between being “on” and being “over.” For example, deposition of a substance “on” a substrate refers to a deposition involving direct physical and tangible contact without an intermediary, such as an intermediary substance, between the substance deposited and the substrate; whereas deposition “over” a substrate, while understood to potentially include deposition “on” a substrate (since being “on” may also accurately be described as being “over”), is understood to include a situation in which one or more intermediaries, such as one or more intermediary substances, are present between the substance deposited and the substrate so that the substance deposited is not necessarily in direct physical and tangible contact with the substrate.

A similar distinction is made in an appropriate particular context of usage, such as in which tangible materials and/or tangible components are discussed, between being “beneath” and being “under.” While “beneath,” in such a particular context of usage, is intended to necessarily imply physical and tangible contact (similar to “on,” as just described), “under” potentially includes a situation in which there is direct physical and tangible contact, but does not necessarily imply direct physical and tangible contact, such as if one or more intermediaries, such as one or more intermediary substances, are present. Thus, “on” is understood to mean “immediately over” and “beneath” is understood to mean “immediately under.”

It is likewise appreciated that terms such as “over” and “under” are understood in a similar manner as the terms “up,” “down,” “top,” “bottom,” and so on, previously mentioned. These terms may be used to facilitate discussion, but are not intended to necessarily restrict scope of claimed subject matter. For example, the term “over,” as an example, is not meant to suggest that claim scope is limited to only situations in which an embodiment is right side up, such as in comparison with the embodiment being upside down, for example. An example includes a flip chip, as one illustration, in which, for example, orientation at various times (e.g., during fabrication) may not necessarily correspond to orientation of a final product. Thus, if an object, as an example, is within applicable claim scope in a particular orientation, such as upside down, as one example, likewise, it is intended that the latter also be interpreted to be included within applicable claim scope in another orientation, such as right side up, again, as an example, and vice-versa, even if applicable literal claim language has the potential to be interpreted otherwise. Of course, again, as always has been the case in the specification of a patent application, particular context of description and/or usage provides helpful guidance regarding reasonable inferences to be drawn.

Unless otherwise indicated, in the context of the present patent application, the term “or” if used to associate a list, such as A, B, or C, is intended to mean A, B, and C, here used in the inclusive sense, as well as A, B, or C, here used in the exclusive sense. With this understanding, “and” is used in the inclusive sense and intended to mean A, B, and C; whereas “and/or” can be used in an abundance of caution to make clear that all the foregoing meanings are intended, although such usage is not required. In addition, the term “one or more,” “at least one” and/or similar terms are used to describe any feature, structure, characteristic, and/or the like in the singular and/or the plural. Furthermore, “and/or” is also used to describe a plurality and/or some other combination of features, structures, characteristics, and/or the like. Likewise, the terms “based”, “based on” and/or similar terms are understood as not necessarily intending to convey an exhaustive list of factors, but to allow for existence of additional factors not necessarily expressly described.

To the extent claimed subject matter is related to one or more particular measurements, such as with regard to physical manifestations capable of being measured physically, such as, without limit, temperature, pressure, voltage, current, electromagnetic radiation, etc., it is believed that claimed subject matter does not fall within the abstract idea judicial exception to statutory subject matter and/or patent eligibility. Rather, it is asserted, that physical measurements are not mental steps and, likewise, are not abstract ideas. Thus, it is understood, of course, that a distribution of scalar numerical values, for example, without loss of generality, substantially in accordance with the foregoing description and/or later description, is related to physical measurements, and is likewise understood to exist as physical states, physical signals and/or physical signal samples.

The terms “correspond”, “reference”, “associate”, and/or similar terms relate to signals, signal samples and/or states, e.g., components of a signal measurement vector, which may be stored in memory and/or employed with operations to generate results, depending, at least in part, on the above-mentioned, signal samples and/or signal sample states. For example, a signal sample measurement vector may be stored in a memory location and further referenced wherein such a reference may be embodied and/or described as a stored relationship. A stored relationship may be employed by associating (e.g., relating) one or more memory addresses to one or more other memory addresses, for example, and may facilitate an operation, involving, at least in part, a combination of signal samples and/or states stored in memory, such as for processing by a processor and/or similar device, for example. Thus, in a particular context, “associating,” “referencing,” and/or “corresponding” may, for example, refer to an executable process of accessing memory contents of two or more memory locations, e.g., to facilitate execution of one or more operations among signal samples and/or states, wherein one or more results of the one or more operations may likewise be employed for additional processing, such as in other operations, or may be stored in the same or other memory locations, as may, for example, be directed by executable instructions. Furthermore, terms “fetching” and “reading” or “storing” and “writing” are to be understood as interchangeable terms for the respective operations, e.g., a result may be fetched (or read) from a memory location; likewise, a result may be stored in (or written to) a memory location.

It is further noted that the terms “type” and/or “like,” if used, such as with a feature, structure, characteristic, and/or the like, using “optical” or “electrical” as simple examples, means at least partially of and/or relating to the feature, structure, characteristic, and/or the like in such a way that presence of minor variations, even variations that might otherwise not be considered fully consistent with the feature, structure, characteristic, and/or the like, do not in general prevent the feature, structure, characteristic, and/or the like from being of a “type” and/or being “like,” (such as being an “optical-type” or being “optical-like,” for example) if the minor variations are sufficiently minor so that the feature, structure, characteristic, and/or the like would still be considered to be substantially present with such variations also present. Thus, continuing with this example, the terms optical-type and/or optical-like properties are necessarily intended to include optical properties. Likewise, the terms electrical-type and/or electrical-like properties, as another example, are necessarily intended to include electrical properties. It should be noted that the specification of the present patent application merely provides one or more illustrative examples and claimed subject matter is intended to not be limited to one or more illustrative examples; however, again, as has always been the case with respect to the specification of a patent application, particular context of description and/or usage provides helpful guidance regarding reasonable inferences to be drawn.

With advances in technology, it has become more typical to employ distributed computing and/or communication approaches in which portions of a process, such as signal processing of signal samples, for example, may be allocated among various devices, including one or more client devices and/or one or more server devices, via a computing and/or communications network, for example. A network may comprise two or more devices, such as network devices and/or computing devices, and/or may couple devices, such as network devices and/or computing devices, so that signal communications, such as in the form of signal packets and/or signal frames (e.g., comprising one or more signal samples), for example, may be exchanged, such as between a server device and/or a client device, as well as other types of devices, including between wired and/or wireless devices coupled via a wired and/or wireless network, for example.

In the context of the present patent application, the term network device refers to any device capable of communicating via and/or as part of a network and may comprise a computing device. While network devices may be capable of communicating signals (e.g., signal packets and/or frames), such as via a wired and/or wireless network, they may also be capable of performing operations associated with a computing device, such as arithmetic and/or logic operations, processing and/or storing operations (e.g., storing signal samples), such as in memory as tangible, physical memory states, and/or may, for example, operate as a server device and/or a client device in various embodiments. Network devices capable of operating as a server device, a client device and/or otherwise, may include, as examples, dedicated rack-mounted servers, desktop computers, laptop computers, set top boxes, tablets, netbooks, smart phones, wearable devices, integrated devices combining two or more features of the foregoing devices, and/or the like, or any combinations thereof. As mentioned, signal packets and/or frames, for example, may be exchanged, such as between a server device and/or a client device, as well as other types of devices, including between wired and/or wireless devices coupled via a wired and/or wireless network, for example, or any combinations thereof. It is noted that the terms, server, server device, server computing device, server computing platform and/or similar terms are used interchangeably. Similarly, the terms client, client device, client computing device, client computing platform and/or similar terms are also used interchangeably. While in some instances, for ease of description, these terms may be used in the singular, such as by referring to a “client device” or a “server device,” the description is intended to encompass one or more client devices and/or one or more server devices, as appropriate. Along similar lines, references to a “database” are understood to mean, one or more databases and/or portions thereof, as appropriate.

It should be understood that for ease of description, a network device (also referred to as a networking device) may be embodied and/or described in terms of a computing device and vice-versa. However, it should further be understood that this description should in no way be construed so that claimed subject matter is limited to one embodiment, such as only a computing device and/or only a network device, but, instead, may be embodied as a variety of devices or combinations thereof, including, for example, one or more illustrative examples.

A network may also include now known, and/or to be later developed arrangements, derivatives, and/or improvements, including, for example, past, present and/or future mass storage, such as network attached storage (NAS), a storage area network (SAN), and/or other forms of device readable media, for example. A network may include a portion of the Internet, one or more local area networks (LANs), one or more wide area networks (WANs), wire-line type connections, wireless type connections, other connections, or any combinations thereof. Thus, a network may be worldwide in scope and/or extent. Likewise, sub-networks, such as may employ differing architectures and/or may be substantially compliant and/or substantially compatible with differing protocols, such as network computing and/or communications protocols (e.g., network protocols), may interoperate within a larger network.

In the context of the present patent application, the term sub-network and/or similar terms, if used, for example, with respect to a network, refers to the network and/or a part thereof. Sub-networks may also comprise links, such as physical links, connecting and/or coupling nodes, so as to be capable to communicate signal packets and/or frames between devices of particular nodes, including via wired links, wireless links, or combinations thereof. Various types of devices, such as network devices and/or computing devices, may be made available so that device interoperability is enabled and/or, in at least some instances, may be transparent. In the context of the present patent application, the term “transparent,” if used with respect to devices of a network, refers to devices communicating via the network in which the devices are able to communicate via one or more intermediate devices, such as one or more intermediate nodes, but without the communicating devices necessarily specifying the one or more intermediate nodes and/or the one or more intermediate devices of the one or more intermediate nodes and/or, thus, may include within the network the devices communicating via the one or more intermediate nodes and/or the one or more intermediate devices of the one or more intermediate nodes, but may engage in signal communications as if such intermediate nodes and/or intermediate devices are not necessarily involved. For example, a router may provide a link and/or connection between otherwise separate and/or independent LANs.

In the context of the present patent application, a “private network” refers to a particular, limited set of devices, such as network devices and/or computing devices, able to communicate with other devices, such as network devices and/or computing devices, in the particular, limited set, such as via signal packet and/or signal frame communications, for example, without a need for re-routing and/or redirecting signal communications. A private network may comprise a stand-alone network; however, a private network may also comprise a subset of a larger network, such as, for example, without limitation, a portion of the Internet. Thus, for example, a network “in the cloud,” such as a private network “in the cloud” may refer to a private network that comprises a subset of the Internet. Likewise, therefore, a computing device and/or network device “in the cloud” may refer to a subset of the Internet that includes the particular device. Although signal packet and/or frame communications (e.g. signal communications) may employ intermediate devices of intermediate nodes to exchange signal packets and/or signal frames, those intermediate devices may not necessarily be included in the private network by not being a source or designated destination for one or more signal packets and/or signal frames, for example. It is understood in the context of the present patent application that a private network may direct outgoing signal communications to devices not in the private network, but devices outside the private network may not necessarily be able to direct inbound signal communications to devices included in the private network.

The Internet refers to a decentralized global network of interoperable networks that comply with the Internet Protocol (IP). It is noted that there are several versions of the Internet Protocol. The term Internet Protocol, IP, and/or similar terms are intended to refer to any version, now known and/or to be later developed. The Internet includes local area networks (LANs), wide area networks (WANs), wireless networks, and/or long-haul public networks that, for example, may allow signal packets and/or frames to be communicated between LANs. The term World Wide Web (WWW or Web) and/or similar terms may also be used, although it refers to a part of the Internet that complies with the Hypertext Transfer Protocol (HTTP). For example, network devices may engage in an HTTP session through an exchange of appropriately substantially compatible and/or substantially compliant signal packets and/or frames. It is noted that there are several versions of the Hypertext Transfer Protocol. The term Hypertext Transfer Protocol, HTTP, and/or similar terms are intended to refer to any version, now known and/or to be later developed. It is likewise noted that in various places in this document substitution of the term Internet with the term World Wide Web (“Web”) may be made without a significant departure in meaning and may, therefore, also be understood in that manner if the statement would remain correct with such a substitution.

Although claimed subject matter is not in particular limited in scope to the Internet and/or to the Web; nonetheless, the Internet and/or the Web may without limitation provide a useful example of an embodiment at least for purposes of illustration. As indicated, the Internet and/or the Web may comprise a worldwide system of interoperable networks, including interoperable devices within those networks. The Internet and/or Web has evolved to a public, self-sustaining facility accessible to potentially billions of people or more worldwide. Also, in an embodiment, and as mentioned above, the terms “WWW” and/or “Web” refer to a part of the Internet that complies with the Hypertext Transfer Protocol. The Internet and/or the Web, therefore, in the context of the present patent application, may comprise a service that organizes stored digital content, such as, for example, text, images, video, etc., through the use of hypermedia, for example. It is noted that a network, such as the Internet and/or Web, may be employed to store electronic files and/or electronic documents.

The terms electronic file and/or the term electronic document are used throughout this document to refer to a set of stored memory states and/or a set of physical signals associated in a manner so as to thereby at least logically form a file (e.g., electronic) and/or an electronic document. That is, it is not meant to implicitly reference a particular syntax, format and/or approach used, for example, with respect to a set of associated memory states and/or a set of associated physical signals. If a particular type of file storage format and/or syntax, for example, is intended, it is referenced expressly. It is further noted an association of memory states, for example, may be in a logical sense and not necessarily in a tangible, physical sense. Thus, although signal and/or state components of a file and/or an electronic document, for example, are to be associated logically, storage thereof, for example, may reside in one or more different places in a tangible, physical memory, in an embodiment.

A Hyper Text Markup Language (“HTML”), for example, may be utilized to specify digital content and/or to specify a format thereof, such as in the form of an electronic file and/or an electronic document, such as a Web page, Web site, etc., for example. An Extensible Markup Language (“XML”) may also be utilized to specify digital content and/or to specify a format thereof, such as in the form of an electronic file and/or an electronic document, such as a Web page, Web site, etc., in an embodiment. Of course, HTML and/or XML are merely examples of “markup” languages, provided as non-limiting illustrations. Furthermore, HTML and/or XML are intended to refer to any version, now known and/or to be later developed, of these languages. Likewise, claimed subject matter is not intended to be limited to examples provided as illustrations, of course.

In the context of the present patent application, the term “Web site” and/or similar terms refer to Web pages that are associated electronically and/or logically to form a particular collection thereof. Also, in the context of the present patent application, “Web page” and/or similar terms refer to an electronic file and/or an electronic document accessible via a network, including by specifying a uniform resource locator (URL) for accessibility via the Web, in an example embodiment. As alluded to above, in one or more embodiments, a Web page may comprise digital content coded (e.g., via computer instructions) using one or more languages, such as, for example, markup languages, including HTML and/or XML, although claimed subject matter is not limited in scope in this respect. Also, in one or more embodiments, application developers may write code (e.g., computer instructions) in the form of JavaScript (or other programming languages), for example, executable by a computing device to provide digital content to populate an electronic document and/or an electronic file in an appropriate format, such as for use in a particular application, for example. Use of the term “JavaScript” and/or similar terms intended to refer to one or more particular programming languages are intended to refer to any version of the one or more programming languages identified, now known and/or to be later developed. Thus, JavaScript is merely an example programming language. As was mentioned, claimed subject matter is not intended to be limited to examples and/or illustrations.

In the context of the present patent application, the terms “entry,” “electronic entry,” “document,” “electronic document,” “content,” “digital content,” “item,” and/or similar terms are meant to refer to signals and/or states in a physical format, such as a digital signal and/or digital state format, e.g., that may be perceived by a user if displayed, played, tactilely generated, etc. and/or otherwise executed by a device, such as a digital device, including, for example, a computing device, but otherwise might not necessarily be readily perceivable by humans (e.g., if in a digital format). For example, digital content may comprise executable instructions, such as stored on a non-transitory storage medium and executable by a processor. Likewise, in the context of the present patent application, digital content provided to a user in a form so that the user is able to readily perceive the underlying content itself (e.g., content presented in a form consumable by a human, such as hearing audio, feeling tactile sensations and/or seeing images or text, as examples) is referred to, with respect to the user, as “consuming” digital content, “consumption” of digital content, “consumable” digital content and/or similar terms. For one or more embodiments, an electronic document and/or an electronic file may comprise a Web page of code (e.g., computer instructions) in a markup language executed or to be executed by a computing and/or networking device, for example. In another embodiment, an electronic document and/or electronic file may comprise a portion and/or a region of a Web page. However, claimed subject matter is not intended to be limited in these respects.

Also, for one or more embodiments, an electronic document and/or electronic file may comprise a number of components. As previously indicated, in the context of the present patent application, a component is physical, but is not necessarily tangible. As an example, components with reference to an electronic document and/or electronic file, in one or more embodiments, may comprise text, for example, in the form of physical signals and/or physical states (e.g., capable of being physically displayed). Typically, memory states, for example, comprise tangible components, whereas physical signals are not necessarily tangible, although signals may become (e.g., be made) tangible, such as if appearing on a tangible display, for example, as is not uncommon. Also, for one or more embodiments, components with reference to an electronic document and/or electronic file may comprise a graphical object, such as, for example, an image, such as a digital image, and/or sub-objects, including attributes thereof, which, again, comprise physical signals and/or physical states (e.g., capable of being tangibly displayed). In an embodiment, digital content may comprise, for example, text, images, audio, video, and/or other types of electronic documents and/or electronic files, including portions thereof, for example.

Also, in the context of the present patent application, the terms attributes (e.g., one or more attributes) and/or parameters (e.g., one or more parameters) may refer to material descriptive of a collection of signal samples, such as one or more electronic documents and/or electronic files, and exist in the form of physical signals and/or physical states, such as memory states. For example, one or more parameters and/or attributes, such as referring to an electronic document and/or an electronic file comprising an image, may include, as examples, time of day at which an image was captured, latitude and longitude of an image capture device, such as a camera, for example, etc. In another example, one or more parameters and/or attributes relevant to digital content, such as digital content comprising a technical article, as an example, may include one or more authors, for example. Claimed subject matter is intended to embrace meaningful, descriptive attributes and/or parameters in any format, so long as the one or more parameters and/or attributes comprise physical signals and/or states, which may include, as examples, collection name (e.g., electronic file and/or electronic document identifier name), technique of creation, purpose of creation, time and date of creation, logical path if stored, coding formats (e.g., type of computer instructions, such as a markup language) and/or standards and/or specifications used so as to be protocol compliant (e.g., meaning substantially compliant and/or substantially compatible) for one or more uses, and so forth.

Signal packet communications and/or signal frame communications, also referred to as signal packet transmissions and/or signal frame transmissions (or merely “signal packets” or “signal frames”), may be communicated between physical nodes of a physical network, where a physical node may comprise one or more network devices and/or one or more computing devices, for example. As an illustrative example, but without limitation, a physical node may comprise one or more sites employing a local network address, such as in a local network address space. Likewise, a device, such as a network device and/or a computing device, may be associated with that physical node. It is also noted that in the context of this patent application, the term “transmission” is intended as another term for a type of signal communication that may occur in any one of a variety of situations. Thus, it is not intended to imply a particular directionality of communication and/or a particular initiating end of a communication path for the “transmission” communication. For example, the mere use of the term in and of itself is not intended, in the context of the present patent application, to have particular implications with respect to the one or more signals being communicated, such as, for example, whether the signals are being communicated “to” a particular device, whether the signals are being communicated “from” a particular device, and/or regarding which end of a communication path may be initiating communication, such as, for example, in a “push type” of signal transfer or in a “pull type” of signal transfer. In the context of the present patent application, push and/or pull type signal transfers are distinguished by which end of a communications path initiates signal transfer.

Thus, a signal packet and/or frame may, as an example, be communicated via a communication channel and/or a communication path, such as comprising a portion of the Internet and/or the Web, from a site via a physical access node coupled to the Internet or vice-versa. Likewise, a signal packet and/or frame may be forwarded via physical network nodes to a target site coupled to a local network, for example. A signal packet and/or frame communicated via the Internet and/or the Web, for example, may be routed via a path, such as either being “pushed” or “pulled,” comprising one or more gateways, servers, etc. that may, for example, route a signal packet and/or frame, such as, for example, substantially in accordance with a target and/or destination address and availability of a network path of network nodes to the target and/or destination address. Although the Internet and/or the Web comprise a network of interoperable networks, not all of those interoperable networks are necessarily available and/or accessible to the public.

In the context of the particular patent application, a network protocol, such as for communicating between devices of a network, may be characterized, at least in part, substantially in accordance with a layered description, such as the so-called Open Systems Interconnection (OSI) seven-layer type of approach and/or description. A network computing and/or communications protocol (also referred to as a network protocol) refers to a set of signaling conventions, such as for communication transmissions, for example, as may take place between and/or among devices in a physical network. In the context of the present patent application, the term “between” and/or similar terms are understood to include “among” if appropriate for the particular usage and vice-versa. Likewise, in the context of the present patent application, the terms “compatible with,” “comply with” and/or similar terms are understood to respectively include substantial compatibility and/or substantial compliance.

A network protocol, such as protocols characterized substantially in accordance with the aforementioned OSI description, has several layers. These layers are referred to as a network stack. Various types of communications (e.g., transmissions), such as network communications, may occur across various layers. A lowest level layer in a network stack, such as the so-called physical layer, may characterize how symbols (e.g., bits and/or bytes) are communicated as one or more signals (and/or signal samples) via a physical medium (e.g., twisted pair copper wire, coaxial cable, fiber optic cable, wireless air interface, combinations thereof, etc.). Progressing to higher-level layers in a network protocol stack, additional operations and/or features may be available via engaging in communications that are substantially compatible and/or substantially compliant with a particular network protocol at these higher-level layers. For example, higher-level layers of a network protocol may, for example, affect device permissions, user permissions, etc.

A network and/or sub-network, in an embodiment, may communicate via signal packets and/or signal frames, such as via participating digital devices and may be substantially compliant and/or substantially compatible with, but is not limited to, now known and/or to be developed, versions of any of the following network protocol stacks: ARCNET, AppleTalk, ATM, Bluetooth, DECnet, Ethernet, FDDI, Frame Relay, HIPPI, IEEE 1394, IEEE 802.11, IEEE-488, Internet Protocol Suite, IPX, Myrinet, OSI Protocol Suite, QsNet, RS-232, SPX, System Network Architecture, Token Ring, USB, PCI and/or X.25. A network and/or sub-network may employ, for example, a version, now known and/or later to be developed, of the following: TCP/IP, UDP, DECnet, NetBEUI, IPX, AppleTalk and/or the like. Versions of the Internet Protocol (IP) may include IPv4, IPv6, and/or other later to be developed versions.

Regarding aspects related to a network, including a communications and/or computing network, a wireless network may couple devices, including client devices, with the network. A wireless network may employ stand-alone, ad-hoc networks, mesh networks, Wireless LAN (WLAN) networks, cellular networks, and/or the like. A wireless network may further include a system of terminals, gateways, routers, and/or the like coupled by wireless radio links, and/or the like, which may move freely, randomly and/or organize themselves arbitrarily, such that network topology may change, at times even rapidly. A wireless network may further employ a plurality of network access technologies, including a version of Long Term Evolution (LTE), WLAN, Wireless Router (WR) mesh, 2nd, 3rd, 4^{th} and/or 5th generation (2G, 3G, 4G, and/or 5G) cellular technology and/or the like, whether currently known and/or to be later developed. Network access technologies may enable wide area coverage for devices, such as computing devices and/or network devices, with varying degrees of mobility, for example.

A network may enable radio frequency and/or other wireless type communications via a wireless network access technology and/or air interface, such as Global System for Mobile communication (GSM), Universal Mobile Telecommunications System (UMTS), General Packet Radio Services (GPRS), Enhanced Data GSM Environment (EDGE), 3GPP Long Term Evolution (LTE), LTE Advanced, Wideband Code Division Multiple Access (WCDMA), Bluetooth, ultra-wideband (UWB), 802.11b/g/n, and/or the like. A wireless network may include virtually any type of now known and/or to be developed wireless communication mechanism and/or wireless communications protocol by which signals may be communicated between devices, between networks, within a network, and/or the like, including the foregoing, of course.

In at least one embodiment, as shown in FIG. 2, a system may comprise a local network (e.g., device 204 and device readable medium 240) and/or another type of network, such as a computing and/or communications network. FIG. 2 shows embodiment 200 of a system that may be employed to implement either type or both types of networks. Network 208 may comprise one or more network connections, links, processes, services, applications, and/or resources to facilitate and/or support communications, such as an exchange of communication signals between a computing device 202, and another computing device 206, which may comprise one or more client computing devices and/or one or more server computing device. In at least one embodiment, network 208 may comprise wireless and/or wired communication links, telephone, and/or telecommunications systems, Wi-Fi networks, Wi-MAX networks, the Internet, a local area network (LAN), a wide area network (WAN), or any combinations thereof.

In an embodiment, example devices in FIG. 2 may comprise features of a client computing device and/or a server computing device. It is further noted that the term computing device, in general, whether employed as a client and/or as a server, or otherwise, refers at least to a processor and a memory connected by a communication bus. A “processor,” for example, is understood to connote a specific structure such as a central processing unit (CPU) of a computing device which may include a control unit and an execution unit, but may include other processors, such. In an aspect, a processor like may simply comprise a device that interprets and executes instructions to process input signals to provide output signals. As such, in the context of the present patent application at least, computing device and/or processor are understood to refer to sufficient structure within the meaning of 35 USC § 112(f) so that it is specifically intended that 35 USC § 112(f) not be implicated by use of the term “computing device,” “processor” and/or similar terms; however, if it is determined, for some reason not immediately apparent, that the foregoing understanding cannot stand and that 35 USC § 112(f), therefore, necessarily is implicated by the use of the term “computing device,” “processor” and/or any other terms, then, it is intended, pursuant to that statutory section, that corresponding structure, material and/or acts for performing one or more functions be understood and be interpreted to be described at least in FIG. 2 and in the text associated with FIG. 2 of the present patent application.

In some circumstances, the operation of a memory device, such as a change in state from a binary one to a binary zero or vice-versa, for example, may comprise a transformation, such as a physical transformation. With particular types of memory devices, such a physical transformation may comprise a physical transformation of an article to a different state or thing. For example, but without limitation, for some types of memory devices, a change in state may involve an accumulation and/or storage of charge or a release of stored charge. Likewise, in other memory devices, a change of state may comprise a physical change, such as a transformation in magnetic orientation. Likewise, a physical change may comprise a transformation in molecular structure, such as from crystalline form to amorphous form or vice-versa. In still other memory devices, a change in physical state may involve quantum mechanical phenomena, such as, superposition, entanglement, and/or the like, which may involve quantum bits (qubits), for example. The foregoing is not intended to be an exhaustive list of all examples in which a change in state from a binary one to a binary zero or vice-versa in a memory device may comprise a transformation, such as a physical, but non-transitory, transformation. Rather, the foregoing is intended as illustrative examples.

Referring again to FIG. 2, processor 220 may comprise one or more circuits, such as digital circuits, to perform at least a portion of a computing procedure and/or process. By way of example, but not limitation, processor 220 may comprise one or more processors, such as graphical processing units (GPUs), controllers, microprocessors, microcontrollers, application specific integrated circuits, digital signal processors, programmable logic devices, field programmable gate arrays, the like, or any combinations thereof. In various implementations and/or embodiments, processor 220 may perform signal processing, typically substantially in accordance with fetched executable computer instructions, such as to manipulate signals and/or states, to construct signals and/or states, etc., with signals and/or states generated in such a manner to be communicated and/or stored in memory, for example.

Memory 222 may store electronic files and/or electronic documents, such as relating to one or more users, and may also comprise a computer readable medium that may carry and/or make accessible digital content, including code and/or instructions, for example, executable by processor 220 and/or some other device, such as a controller, as one example, capable of executing computer instructions, for example. As previously mentioned, the term electronic file and/or the term electronic document are used throughout this document to refer to a set of stored memory states and/or a set of physical signals associated in a manner so as to thereby form an electronic file and/or an electronic document. That is, it is not meant to implicitly reference a particular syntax, format and/or approach used, for example, with respect to a set of associated memory states and/or a set of associated physical signals. It is further noted an association of memory states, for example, may be in a logical sense and not necessarily in a tangible, physical sense. Thus, although signal and/or state components of an electronic file and/or electronic document, are to be associated logically, storage thereof, for example, may reside in one or more different places in a tangible, physical memory, in an embodiment.

Algorithmic descriptions and/or symbolic representations are examples of techniques used by those of ordinary skill in the signal processing and/or related arts to convey the substance of their work to others skilled in the art. An algorithm is, in the context of the present patent application, and generally, is a self-consistent sequence of operations and/or similar signal processing leading to a desired result. In the context of the present patent application, operations and/or processing involve physical manipulation of physical quantities. Typically, although not necessarily, such quantities may take the form of electrical and/or magnetic signals and/or states capable of being stored, transferred, combined, compared, processed and/or otherwise manipulated, for example, as electronic signals and/or states making up components of various forms of digital content, such as signal measurements, text, images, video, audio, etc.

It has proven convenient at times, principally for reasons of common usage, to refer to such physical signals and/or physical states as bits, values, elements, attributes, parameters, symbols, characters, terms, numbers, numerals, measurements, content and/or the like. It should be understood, however, that all of these and/or similar terms are to be associated with appropriate physical quantities and are merely convenient labels. Unless specifically stated otherwise, as apparent from the preceding discussion, it is appreciated that throughout this specification discussions utilizing terms such as “processing,” “computing,” “calculating,” “determining,” “establishing,” “obtaining,” “identifying,” “selecting,” “generating,” and/or the like may refer to actions and/or processes of a specific apparatus, such as a special purpose computer and/or a similar special purpose computing and/or network device. In the context of this specification, therefore, a special purpose computer and/or a similar special purpose computing and/or network device is capable of processing, manipulating and/or transforming signals and/or states, typically in the form of physical electronic and/or magnetic quantities, within memories, registers, and/or other storage devices, processing devices, and/or display devices of the special purpose computer and/or similar special purpose computing and/or network device. In the context of this particular patent application, as mentioned, the term “specific apparatus” therefore includes a general-purpose computing and/or network device, such as a general-purpose computer, once it is programmed to perform particular functions, such as pursuant to program software instructions.

FIG. 2 also illustrates device 204 as including a component 232 operable with input/output devices and communication interface 230, for example, so that signals and/or states may be appropriately communicated between devices, such as device 204 and an input device and/or device 204 and an output device. A user may make use of an input device, such as a computer mouse, stylus, track ball, keyboard, and/or any other similar device capable of receiving user actions and/or motions as input signals. Likewise, for a device having speech to text capability, a user may speak to a device to generate input signals, referred to, for example, as a speaking event. A user may make use of an output device, such as a display, a printer, etc., and/or any other device capable of providing signals and/or generating stimuli for a user, such as visual stimuli, audio stimuli and/or other similar stimuli.

In the preceding description, various aspects of claimed subject matter have been described. For purposes of explanation, specifics, such as amounts, systems and/or configurations, as examples, were set forth. In other instances, well-known features were omitted and/or simplified so as not to obscure claimed subject matter. While certain features have been illustrated and/or described herein, many modifications, substitutions, changes and/or equivalents will now occur to those skilled in the art. It is, therefore, to be understood that the appended claims are intended to cover all modifications and/or changes as fall within claimed subject matter.

In at least one example, structures described herein can also be described as method(s) of forming those structures or apparatuses, and method(s) of operation of these structures or apparatuses. The following examples are provided that illustrate at least one example. An example can be combined with any other example. As such, at least one example can be combined with at least another example without changing the scope of an example.

Example 1 is an apparatus comprising: at least one computing device comprising at least one processor and at least one non-transitory storage medium; wherein the at least one non-transitory storage medium includes executable instructions stored thereon; wherein executing the instructions by the at least one processor are to result in processing sensor measurements, including images, from at least one optical sensor array, of at least one object, with a three-dimensional pose estimation model to produce at least one substantially view-invariant morphometric measurement estimate of the at least one object, wherein the at least one optical sensor array comprises at least one sensor.

Example 2 is an apparatus according to any example herein, in particular example 1, wherein the at least one processor is to process the sensor measurements by employment of a validated statistical model to estimate and/or predict physical attributes of the at least one object.

Example 3 is an apparatus according to any example herein, in particular example 2, wherein the at least one object comprises multiple living objects from an object population.

Example 4 is an apparatus according to any example herein, in particular example 3, wherein t the at least one processor is to process the sensor measurements by estimation and/or prediction of physical attributes for multiple types of the multiple living objects of the object population with a validated statistical model.

Example 5 is an apparatus according to any example herein, in particular example 4, wherein the at least one processor is to estimate and/or predict the physical attributes for the multiple types of the multiple living objects of the object population by processing to report an overall health, demographic and/or growth status of the object population.

Example 6 is an apparatus according to any example herein, in particular example 1, wherein the at least one processor is to process the sensor measurements by processing with a trained machine learning process to produce the at least one substantially view-invariant three-dimensional morphometric measurement estimate.

Example 7 is an apparatus according to any example herein, in particular example 6, wherein the trained machine learning process comprises a trained deep convolutional neural network.

Example 8 is an apparatus according to any example herein, in particular example 1, wherein the at least one processor is to process the sensor measurements including processing images, from the at least one optical sensor array, by performing image rectification and image triangulation.

Example 9 is an apparatus according to any example herein, in particular example 1, wherein the at least one processor is to process the sensor measurements by performing correction and/or calibration of the sensor measurements.

Example 10 is an apparatus according to any example herein, in particular example 1, further comprising at least one physical support platform; wherein the at least one optical sensor array includes a stereoscopic camera, wherein the at least one optical sensor array is physically integrated with the at least one physical support platform, and wherein the at least one processor is to transport the sensor measurements to an external system to perform the sensor measurement processing.

Example 11 is an apparatus according to any example herein, in particular example 10, wherein the at least one physical support platform comprises a movable platform.

Example 12 is an apparatus according to any example herein, in particular example 11, wherein the movable platform comprises an aerial vehicle, a water vehicle, an underwater vehicle or any combinations thereof.

Example 13 is an apparatus according to any example herein, in particular example 10, wherein the external system comprises at least one server in a cloud.

Example 14 is an article comprising: a non-transitory storage medium; wherein the non-transitory storage medium includes executable instructions stored thereon, wherein execution of the stored instructions by a processor is to process sensor measurements, including images, from at least one sensor array that is to include at least one sensor, of at least one object, with a three-dimensional pose estimation model to produce at least one substantially view-invariant morphometric measurement estimate of the at least one object.

Example 15 is an article according to any example herein, in particular example 14, wherein the three-dimensional pose estimation model includes a trained machine learning process to produce the at least one substantially view-invariant morphometric measurement estimate.

Example 16 is an article according to any example herein, in particular example 15, wherein the trained machine learning process comprises a trained deep convolutional neural network.

Example 17 is an article according to any example herein, in particular example 14, wherein the execution of the stored instructions is to process sensor measurements, including images, from the at least one sensor array, including to perform image rectification and image triangulation.

Example 18 is an article according to any example herein, in particular example 14, wherein the at least one sensor of the at least one sensor array comprises a stereoscopic camera.

Example 19 is an article according to any example herein, in particular example 14, wherein execution of the stored instructions is to process sensor measurements by performing correction and/or calibration of the sensor measurements.

Example 20 is an article according to any example herein, in particular example 18, wherein the at least one object comprises multiple living objects from an object population.

Example 21 is an article according to any example herein, in particular example 20, wherein the execution of the stored instructions is to estimate and/or predict physical attributes for multiple types of the multiple living objects of the object population with a validated statistical model.

Example 22 is an article according to any example herein, in particular example 21, wherein the estimations and/or predictions of the physical attributes of the object population are further processed to report an overall health, demographic and/or growth status of the object population.

Example 23 is a method comprising: processing sensor measurements, including images, from at least one sensor array including at least one sensor, wherein the at least one sensor array is integrated into at least one moveable physical support platform; and generating at least one substantially view-invariant morphometric measurement estimate of at least one object from the processed sensor measurements; wherein the sensor measurements are made with respect to the at least one object and wherein the sensor measurements are processed with a three-dimensional pose estimation model.

Example 24 is a method according to any example herein, in particular example 23, wherein the sensor measurements processed with the three-dimensional pose estimation model comprise sensor measurements processed with a trained machine learning process.

Example 25 is an article according to any example herein, in particular example 24, wherein the sensor measurements processed with a trained machine learning process comprise sensor measurements processed with a trained deep convolutional neural network.

Example 26 is a method according to any example herein, in particular example 23, wherein the at least one object comprises multiple living objects from an object population; and wherein the generating comprises generating from the processed sensor measurements multiple substantially view-invariant morphometric measurement estimates of the multiple living objects from the object population.

Example 27 is a method according to any example herein, in particular example 26, and further comprising estimating and/or predicting physical attributes for the multiple living objects of the object population with a validated statistical model based at least in part on the generated multiple substantially view-invariant morphometric measurement estimates of multiple types of the multiple living objects from the object population.

Example 28 is a method according to any example herein, in particular example 27, wherein the estimating and/or predicting physical attributes for the multiple types of the multiple living objects from the object population are further to report an overall health, demographic and/or growth status of the object population.

Example 29 is a method according to any example herein, in particular example 23, wherein the processing sensor measurements, including images, from at least one sensor array including at least one sensor comprises processing sensor measurements, including images, from the at least one sensor array that is to include at least one sensor wherein the at least one sensor of the at least one sensor array comprises a stereoscopic camera.

We claim:

1. An apparatus comprising: at least one computing device comprising at least one processor and at least one non-transitory storage medium; wherein the at least one non-transitory storage medium includes executable instructions stored thereon; wherein executing the instructions by the at least one processor are to result in processing sensor measurements, including images, from at least one optical sensor array, of at least one object, with a three-dimensional pose estimation model to produce at least one substantially view-invariant morphometric measurement estimate of the at least one object, wherein the at least one optical sensor array comprises at least one sensor.

2. The apparatus of claim 1, wherein the at least one processor is to process the sensor measurements by employment of a validated statistical model to estimate and/or predict physical attributes of the at least one object.

3. The apparatus of claim 2, wherein the at least one object comprises multiple living objects from an object population.

4. The apparatus of claim 3, wherein t the at least one processor is to process the sensor measurements by estimation and/or prediction of physical attributes for multiple types of the multiple living objects of the object population with a validated statistical model.

5. The apparatus of claim 4, wherein the at least one processor is to estimate and/or predict the physical attributes for the multiple types of the multiple living objects of the object population by processing to report an overall health, demographic and/or growth status of the object population.

6. The apparatus of claim 1, wherein the at least one processor is to process the sensor measurements by processing with a trained machine learning process to produce the at least one substantially view-invariant three-dimensional morphometric measurement estimate.

7. The apparatus of claim 6, wherein the trained machine learning process comprises a trained deep convolutional neural network.

8. The apparatus of claim 1, wherein the at least one processor is to process the sensor measurements including processing images, from the at least one optical sensor array, by performing image rectification and image triangulation.

9. The apparatus of claim 1, wherein the at least one processor is to process the sensor measurements by performing correction and/or calibration of the sensor measurements.

10. The apparatus of claim 1, further comprising at least one physical support platform; wherein the at least one optical sensor array includes a stereoscopic camera, wherein the at least one optical sensor array is physically integrated with the at least one physical support platform, and wherein the at least one processor is to transport the sensor measurements to an external system to perform the sensor measurement processing.

11. The apparatus of claim 10, wherein the at least one physical support platform comprises a movable platform.

12. The apparatus of claim 11, wherein the movable platform comprises an aerial vehicle, a water vehicle, an underwater vehicle or any combinations thereof.

13. The apparatus of claim 10, wherein the external system comprises at least one server in a cloud.

14. An article comprising: a non-transitory storage medium; wherein the non-transitory storage medium includes executable instructions stored thereon, wherein execution of the stored instructions by a processor is to process sensor measurements, including images, from at least one sensor array that is to include at least one sensor, of at least one object, with a three-dimensional pose estimation model to produce at least one substantially view-invariant morphometric measurement estimate of the at least one object.

15. The article of claim 14, wherein the three-dimensional pose estimation model includes a trained machine learning process to produce the at least one substantially view-invariant morphometric measurement estimate.

16. The article of claim 14, wherein the execution of the stored instructions is to process sensor measurements, including images, from the at least one sensor array, including to perform image rectification and image triangulation.

17. The article of claim 14, wherein the at least one sensor of the at least one sensor array comprises a stereoscopic camera.

18. The article of claim 14, wherein execution of the stored instructions is to process sensor measurements by performing correction and/or calibration of the sensor measurements.

19. The article of claim 18, wherein the execution of the stored instructions is to estimate and/or predict physical attributes for multiple types of multiple living objects of an object population with a validated statistical model, and wherein the estimations and/or predictions of the physical attributes of the object population are further processed to report an overall health, demographic and/or growth status of the object population.

20. A method comprising:
processing sensor measurements, including images, from at least one sensor array including at least one sensor, wherein the at least one sensor array is integrated into at least one moveable physical support platform; and
generating at least one substantially view-invariant morphometric measurement estimate of at least one object from the processed sensor measurements; wherein the sensor measurements are made with respect to the at least one object and wherein the sensor measurements are processed with a three-dimensional pose estimation model.
